(19) United States
(12) Patent Application Publication
(10) Pub. No.: US 2013/0260962 A1
(43) Pub. Date: Oct. 3, 2013

(54) ADAPTIVE POWER SOURCE CONTROL SYSTEM

(71) Applicant: Wei Li, Peoria, IL (US)

(72) Inventor: Wei Li, Peoria, IL (US)

(21) Appl. No.: 13/436,139

(22) Filed: Mar. 30, 2012

(51) Int. Cl. B60W 10/06; B60W 10/10

(52) U.S. Cl. 477/107

(57) ABSTRACT

A method of controlling a power source associated with a machine includes determining a difference between an underspeed setpoint associated with a peak power source torque and a first power source speed. The method also includes determining a torque distribution associated with the power source and at least one parasitic load receiving power from the power source. The torque distribution is based on the difference and respective torque priority values associated with the power source and the at least one parasitic load. The method further includes providing torque from the power source to the at least one parasitic load based on the torque distribution and modifying at least one of the respective torque priority values. Modifying at least one of the torque priority values reduces a difference between the underspeed set point and a second power source speed different than the first power source speed.

### TECHNICAL FIELD

This disclosure relates generally to a control system and, more particularly, to a system and method of controlling a power source.

### BACKGROUND

Machines such as, for example, wheel loaders, track type tractors, and other types of heavy machinery can be used for a variety of tasks. These machines include a power source, which may be, for example, an engine, such as a diesel engine, gasoline engine, or natural gas engine that provides the power required to complete such tasks. To effectively maneuver the machine during performance of such tasks, the machines also include a transmission that is capable of transmitting the power generated by the engine to various drivetrain components over a wide range of conditions.

For example, such machines commonly use a continuously variable transmission (“CVT”) to direct engine torque to traction devices, such as wheels or tracks, that propel the machine. A CVT is capable of providing a desired output torque to such components, at any speed within its operating range, by continuously changing the ratio of the transmission. The engine and/or the CVT may also be used to assist in braking the machine. For example, during operations in which the machine is required to change travel directions at relatively high load, the engine and the CVT may be configured to provide a retarding torque to the traction devices in order to stop the machine.

For example, upon loading an exemplary wheel loader bucket with material from a pile, the wheel loader may be directed to travel in a reverse direction away from the pile. While traveling in the reverse direction under such a relatively high load, the wheel loader may be controlled to stop, and to move in a forward direction so that the material can be carried to a dump truck, or other unload location. Although engine speed may be increased during such high-load direction changes to provide retarding torque to the traction devices via the CVT, the combined retarding torque provided by the engine and CVT may be inadequate to absorb all of the energy associated with braking the machine in a timely manner. As a result, the efficiency of the machine during repeated loading cycles may suffer. Although additional loads and/or torque demands may be placed on the CVT and/or the engine to further assist with machine braking, known control systems are not configured to manage the combination of such loads such that the load cycle efficiency of the machine is maximized. Instead, traditional power systems including an engine and a CVT are controlled by measuring engine speed, and changing the ratio of the transmission to keep the engine within a defined speed range. Such systems typically focus on protecting machine components from damage caused by engine overspeed.

It is also understood that under certain operating conditions the engine may not be capable of meeting the cumulative torque demand of the various machine components. For example, in order to load the exemplary wheel loader bucket described above with material from a pile, the wheel loader may be driven into the pile, and upon impacting the pile, the operator may raise the bucket and/or tilt the bucket toward the machine. While moving the bucket in this way, the operator may also begin to move the wheel loader in the reverse direction away from the pile. Such operations may place a relatively high torque demand on the engine, and in some operating conditions, the torque required to simultaneously perform the requested operations may exceed the maximum or peak torque capable of being provided by the engine. In such operating conditions, engine speed may initially increase, in response to the increased demand, until the peak engine torque is reached. However, if the torque demand continues to exceed the peak engine torque, engine speed may rapidly decrease, causing the engine to “lug” or stall. Such lugging can be harmful to engine and/or machine components, and may reduce the operational efficiency of the machine during the operations described above. Thus, in an effort to avoid engine lugging, known control systems typically utilize a proportional integration differential (“PID”) or other like software/hardware to limit the torque distributed to the bucket, traction devices, and/or other machine components during operations in which the combined torque demand exceeds the peak engine torque.

For example, U.S. Pat. No. 6,385,970 to Kuras et al. discloses a system that includes an engine, a hydraulic CVT, and a control system in communication with the engine and the CVT. The control system of the '970 patent is paired with a hydro-mechanical drive system that is operable to sense engine speed and create an output speed signal. The control system is further operable to compare the engine speed signal to an underspeed value and produce an error signal. The error signal is used to produce a command signal that controls the transmission ratio to manage the load on the engine.

While the control system of the '970 patent may incorporate various strategies to increase the amount of engine and/or CVT retarding torque available for braking the machine, the control system does not seek to minimize the time required to brake the machine during various loading and unloading cycles. As a result, the control system of the '970 patent does not optimize a loading cycle efficiency of the machine. In addition, while the control system taught in the '970 patent may limit the amount of torque distributed to machine components during periods of relatively high torque demand, the control system does not manage such torque distribution in response to changes in engine speed. As a result, the distribution of engine torque to various machine components is not optimized when, for example, the cumulative torque demanded by these components exceeds the peak engine torque.

The present disclosure is directed towards overcoming one or more of the problems as set forth above.

### SUMMARY OF THE INVENTION

In an exemplary embodiment of the present disclosure, a method of controlling a power source associated with a machine includes determining a difference between an underspeed setpoint associated with a peak power source torque and a first power source speed. The method also includes determining a torque distribution associated with the power source and at least one parasitic load receiving power from the power source. The torque distribution is based on the difference and respective torque priority values associated with the power source and the at least one parasitic load. The method further includes providing torque from the power source to the at least one parasitic load based on the torque distribution and modifying at least one of the respective torque priority values. Modifying at least one of the torque priority values reduces a difference between the underspeed set point and a second power source speed different than the first power source speed.

In another exemplary embodiment of the present disclosure, a method of controlling a power source associated with a machine includes determining a cumulative torque demand based on signals received from an implement and a traction device, the implement and the traction device receiving power from the power source. The method also includes determining that the torque demand exceeds a peak power source torque and determining, in response to determining that the torque demand exceeds the peak power source torque, a first difference between a first power source speed and an underspeed setpoint. The method further includes determining a first torque distribution associated with the power source, the implement, and the traction device. The first torque distribution is based on the first difference and respective torque priority values associated with the power source, the implement, and the traction device. The method also includes modifying at least one of the torque priority values to generate a first modified torque priority value based on the first difference, and determining, in a closed-loop manner, at least one additional torque distribution. The at least one additional torque distribution is based on the first modified torque priority value and a second power source speed different than the first power source speed. In addition, the at least one additional torque distribution limits a decrease in power source speed.

In yet another exemplary embodiment of the present disclosure, a machine includes a power source, at least one parasitic load receiving power from the power source, and a transmission coupled to the power source. The machine also includes a control system in communication with the power source, the at least one parasitic load, and the transmission. The control system is operable to determine a difference between an underspeed setpoint associated with a peak power source torque, and a first power source speed. The control system is also operable to determine a torque distribution associated with the power source and the at least one parasitic load. The torque distribution is based on the difference and respective torque priority values associated with the power source and the at least one parasitic load. The control system is also operable to modify at least one of the respective torque priority values. Modifying at least one of the torque priority values reduces a difference between the underspeed set point and a second power source speed different than the first power source speed.

### BRIEF DESCRIPTION OF THE DRAWINGS

FIG. 1 is a schematic illustration of a control system according to an exemplary embodiment of the present disclosure.

FIG. 2 is a graph illustrating a relationship between power source torque and power source speed according to an exemplary embodiment of the present disclosure.

FIG. 3 is a flow chart illustrating a control method according to an exemplary embodiment of the present disclosure.

### DETAILED DESCRIPTION

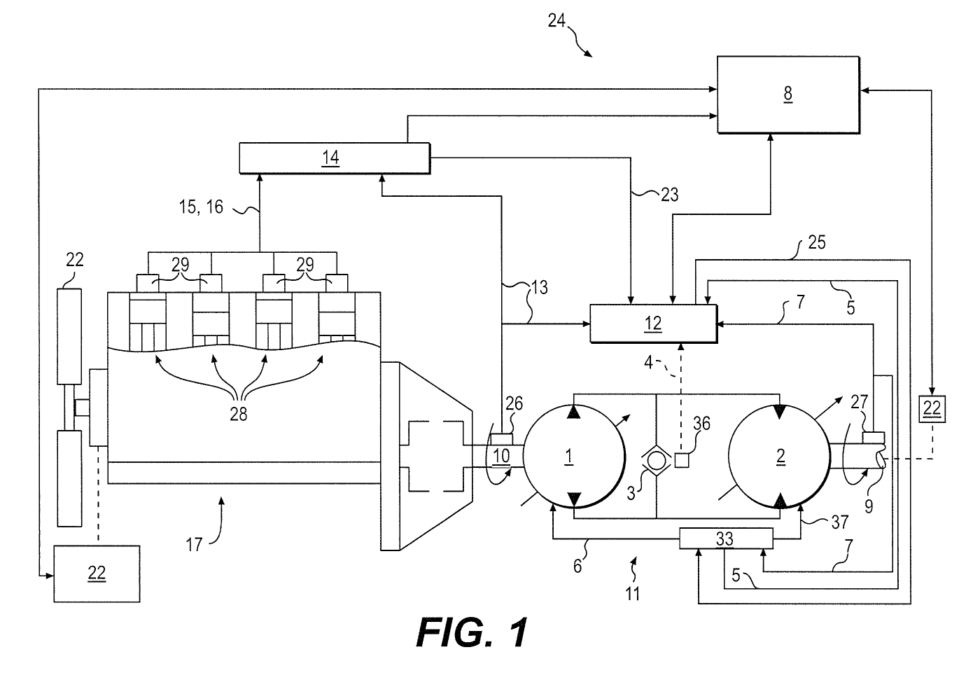

FIG. 1 illustrates an exemplary control system 24 of the present disclosure. The control system 24 may be used, for example, with a power source 17 and a transmission 11 associated with a machine (not shown). Such a machine may be, for example, any mobile or stationary machine used to perform work or other tasks. Such exemplary machines may include, but are not limited to, wheel loaders, motor graders, track-type tractors, excavators, power generators, on-highway vehicles, off-highway vehicles, and/or other like equipment. Such machines may be used to perform tasks in, for example, mining, excavating, construction, farming, transportation, and/or other like environments or applications.

In the exemplary embodiment of FIG. 1, the power source 17 is an engine, such as an internal combustion engine. The engine may be a diesel engine, a gasoline engine, a natural gas engine, or any other engine readily apparent to one skilled in the art. It is contemplated that the control system 24 may be used with other types of power sources such as, for example, fuel cells.

As illustrated in FIG. 1, the power source 17 may include a plurality of combustion chambers 28, and a fuel injector 29 may be associated with each combustion chamber 28. In the illustrated embodiment, the power source 17 includes four combustion chambers 28 and four associated fuel injectors 29. One skilled in the art will readily recognize, however, that power source 17 may include a greater or lesser number of combustion chambers 28, and that combustion chambers 28 may be disposed in an “in-line” configuration, a “V” configuration, or any other conventional configuration.

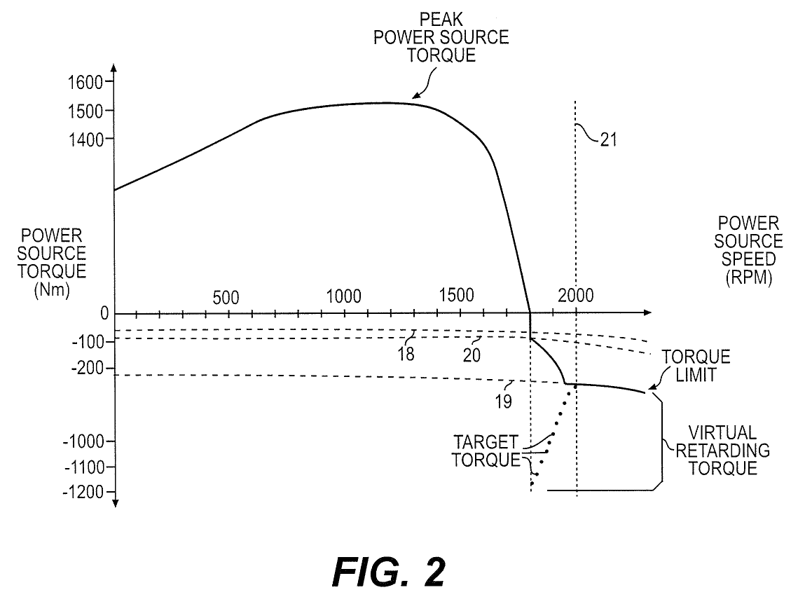

The power source 17 may be configured to provide an output torque to the transmission 11 and/or other components of the machine across a range of power source speeds. FIG. 2 illustrates an exemplary torque curve of the power source 17. The torque curve of FIG. 2 illustrates a relationship between the speed of power source 17 and the resulting power source torque, according to an exemplary embodiment of the present disclosure.

As shown in FIG. 2, the power source 17 may have and/or may be characterized by a torque threshold 18. For the purposes of this disclosure, the “power source torque threshold” 18 may be defined as the maximum retarding torque that the power source 17 is capable of providing to the machine via the transmission 11. The power source 17 may be configured to provide such a retarding torque to assist in, for example, braking the machine with which the power source 17 is associated. It is understood that the retarding torques referred to herein may be directed to, for example, the wheels, tracks, and/or other traction devices of the machine, via the transmission 11 and/or the power source 17, to assist in such braking.

As shown in FIG. 2, the power source torque threshold 18 may be associated with a negative torque value. For example, in embodiments in which the power source 17 is used to assist in braking the machine, the torque output by the power source 17 may decrease from a positive peak torque value while the power source 17 is operating at approximately 1200 rpm, to the power source torque threshold 18 while the power source 17 is operating between approximately 1600 rpm and approximately 2000 rpm. Accordingly, as the torque output by the power source 17 decreases and approaches the power source torque threshold 18, the power source torque may change sign. As the power source torque increases in magnitude in the negative direction, such as from approximately 0 Nm to approximately −60 Nm, the magnitude of the retarding torque provided to the machine and/or transmission 11 by the power source 17 increases. As shown in FIG. 2, in exemplary embodiments, the power source torque threshold 18 may have a value between approximately −25 Nm and approximately −200 Nm. In further exemplary embodiments, the power source torque threshold 18 may have a value between approximately −50 Nm and approximately −100 Nm.

In exemplary embodiments, one or more machine components operably connected to, receiving power from, and/or otherwise associated with the power source 17 may also assist in providing a retarding torque during machine operation. For example, the transmission 11 may be coupled to the power source 17 through various known couplings, shafts, and/or other structures described in greater detail below. As a result, during operation of the machine, resistance and/or friction losses associated with movement of the gears, bearings, shafts, and/or other transmission components may additively contribute to the total retarding torque available for braking the machine. The cumulative retarding torque available from the power source 17 and the exemplary resistance and/or friction losses of the transmission 17 is represented by the combined power source and transmission torque threshold 20 illustrated in FIG. 2. It is understood that, for a given power source speed, the actual retarding torque value associated with the resistance and/or friction losses of the transmission 17 may be calculated as the difference between the power source torque threshold 18 and the combined power source and transmission torque threshold 20. In exemplary embodiments, such a retarding torque may have a value between approximately −25 Nm and approximately −100 Nm.

In addition, one or more parasitic loads 22 may be operatively coupled to, may receive power from, and/or may be otherwise associated with the power source 17 and/or the transmission 11. Such parasitic loads 22 may include, for example, a power source cooling fan, a hydraulic pump associated with an arm, tool, bucket traction device, rotation device, and/or other implement of the machine, and a hydraulic pump associated with the power source 17. During operation, such parasitic loads 22 may be a further source of retarding torque available for braking the machine. Such parasitic loads 22 may additively contribute to the total available retarding torque as described above with respect to the resistance and/or friction losses of the transmission 17. The cumulative retarding torque available from the power source 17, the exemplary resistance and/or friction losses of the transmission 17, and from simultaneous operation of all of the parasitic loads 22 associated with the power source 17 and/or the transmission 11 is represented by the parasitic load threshold 19 illustrated in FIG. 2. It is understood that, for a given power source speed, the actual retarding torque value associated with simultaneously operating all such parasitic loads 22 may be calculated as the difference between the combined threshold 20 and the parasitic load torque threshold 19. In exemplary embodiments, such a retarding torque may have a value between approximately −25 Nm and approximately −150 Nm.

Thus, the parasitic load torque threshold 19 may be representative of a torque limit associated with the machine. For the purposes of this disclosure, such a “torque limit” may be defined as the cumulative maximum retarding torque that the power source 17, the transmission 11, and the parasitic loads 22 described above are capable of providing for braking the machine without failure of a power source component, transmission component, parasitic load component, or a linkage associated with such components. It is understood that such retarding torque may increase in magnitude in the negative direction as the torque limit is approached. In exemplary embodiments, a torque limit associated with the power source 17 may comprise a combination of the power source torque threshold 18, and at least one additional torque threshold associated with a torque required by a parasitic load 22 receiving power from the power source 17. For example, as shown in FIG. 2, the torque limit associated with power source 17 may have a value equal to the combined power source and transmission torque threshold 20 and the parasitic load torque threshold 19. Thus, the torque limit may be a physical retarding threshold and/or capacity of the control system 24, beyond which, damage and/or failure may occur to one or more system components. In exemplary embodiments, the torque limit may be static, and may have a value between approximately −200 Nm and approximately −400 Nm. In still further exemplary embodiments, the torque limit may have a value between approximately −200 Nm and approximately −300 Nm.

With continued reference to FIG. 1, an input drive member such as, for example, a countershaft 10 may connect the power source 17 to the transmission 11 at an interface between the power source 17 and the transmission 11. The transmission 11 may also include an output driven member such as, for example, an output shaft 9. As described in greater detail below, the transmission 11 may convert an input rotation of countershaft 10 into an output rotation of output shaft 9. In this manner, power and/or torque generated by the power source 17 may be transmitted to the output shaft 9, and the output shaft 9 may transmit such power and/or torque to one or more parasitic loads 22 and to the various traction devices of the machine.

In additional exemplary embodiments, the transmission 11 may be configured to provide an input rotation of the countershaft 10 to the power source 17, thereby transmitting input power and/or torque to the power source 17. In exemplary embodiments, such input power and/or torque provided to the power source 17 by the transmission 11 may be used to assist in braking the machine. It is understood that the transmission 11 may comprise any known type of transmission, and in exemplary embodiments in which the transmission 11 is configured to provide power and/or torque to the power source 17, the transmission 11 may comprise a CVT. As shown in FIG. 1, the transmission 11 may be a hydraulic CVT.

Alternatively, in additional exemplary embodiments, the transmission 11 may be an electric CVT or other type of CVT apparent to one skilled in the art.

A CVT generally consists of a driving element, a driven element, and a ratio controller 33. In the hydraulic CVT illustrated in FIG. 1, the driving element may be a pump 1, such as a variable displacement pump, and the driven element may be a motor 2, such as a variable displacement motor. In an electric CVT, on the other hand, the driving element may be an electric generator and the driven element may be an electric motor.

In the hydraulic CVT of FIG. 1, the ratio controller 33 may be configured to manipulate the displacement of the pump 1 with a pump command signal 6, and may be configured to manipulate the displacement of the motor 2 with a motor command signal 37. By manipulating displacements in this way, the ratio controller 33 may vary and/or otherwise control the output rotation of output shaft 9. The motor 2 may be fluidly connected to the pump 1 by conduits that supply and return fluid to and from the pump 1 and motor 2. As a result, the pump 1 may be configured to drive the motor 2 by fluid pressure. The transmission 11 may also include a resolver 3, allowing for a measurement of a pressure differential between the two conduits of supply and return fluid. The pressure differential between the two conduits and/or the displacement of the motor 2 may be used to determine an output torque of the transmission 11.

The ratio controller 33 may also be configured to control the ratio of the transmission output speed to the transmission input speed. In the exemplary embodiment shown in FIG. 1, the ratio controller 33 may be in communication with both the driving element and the driven element, and may adjust the ratio of the transmission output speed to the transmission input speed, as limited by the power output of the power source 17. When both output torque and output speed increases are demanded of the transmission 11, a demand for increased power is transmitted to the power source 17 by the ratio controller 33. Likewise, when both output torque and output speed decreases are demanded of the transmission 11, a demand for decreased power is transmitted to the power source 17.

The ratio of transmission output speed to transmission input speed, at a particular power source output power, may be controlled by manipulating the displacement of the pump 1 and motor 2. As the machine encounters a relatively rapid change in loading conditions such as, for example, a change from a high ground speed with a low load to a low ground speed with a high load, the ratio controller 33 may shift the ratio of the transmission 11 from a high speed output to a low speed output. It is understood that such a relatively rapid change in loading conditions may occur, for example, upon driving the machine into a pile of material with an empty bucket, lifting the bucket loaded with material, and backing the machine away from the pile of material in a reverse direction. When shifting from a high speed output to a low speed output, the ratio controller 33 may decrease the flow of fluid supplied to the motor 2 by decreasing the displacement of the pump 1 to reduce the torque load or power load of the power source 17. The ratio controller 33 may also increase the displacement of the motor 2 to decrease the load on the power source 17. If the machine encounters a reduction in load, the ratio controller 33 may increase the displacement of the pump 1 and may decrease the displacement of the motor 2. The increased displacement of the pump 1 combined with the decreased displacement of the motor 2 results in an increase in machine travel speed and a reduction in the available torque.

Alternatively, in an electric CVT, the ratio of transmission output speed to input speed, at a particular power source output power, may be controlled by manipulating a torque command signal to the electric motor described above. As the machine encounters a relatively rapid change in loading conditions such as, for example, changing from a high ground speed with a low load to a low ground speed with a high load, the ratio controller 33 may alter the torque command signal sent to the electric motor to produce additional torque. In turn, the electric motor may demand additional power capacity from the generator described above in the form of additional current.

As shown in FIG. 1, one or more sensors may be associated with the transmission 11, the power source 17, and/or the parasitic loads 22. These sensors may be configured to generate signals indicative of one or more operating characteristics of the transmission 11, the power source 17, and/or the parasitic loads 22, respectively. For example, in the hydraulic transmission 11 of FIG. 1, a pressure sensor 36 may be configured to provide a fluid pressure signal 4 from the resolver 3 to a transmission controller 12 associated with the control system 24. In addition, a power source speed sensor 26 may be configured to produce a power source speed signal 13, and a transmission speed sensor 27 may be configured to produce a transmission speed signal 7. The speed sensors 26, 27 may be, for example, in the form of magnetic pick-up sensors configured to produce signals corresponding to the rotational speeds of the countershaft 10 and the output shaft 9, respectively. These sensors 26, 27 may also be capable of determining the angular position and/or direction of rotation of the countershaft 10 and output shaft 9. The speed sensors 26, 27 may provide the respective signals to the transmission controller 12 and/or to a power source observer 14 associated with the control system 24.

The power source observer 14 and the transmission controller 12 may be operably connected and/or otherwise in communication with each other. Additionally, the transmission controller 12 and the power source observer 14 may be operably connected to and/or otherwise in communication with a machine controller 8 of the control system 24. Although FIG. 1 illustrates the transmission controller 12, the power source observer 14, and the machine controller 8 as being separate components of the control system 24, in additional exemplary embodiments, the transmission controller 12, the power source observer 14, and/or the machine controller 8 may be combined into and/or may otherwise embody a single controller, microprocessor, and/or other known control component. Numerous commercially available microprocessors can be configured to perform the functions of the controller 12, the power source observer 14, and the machine controller 8. One or more of the controller 12, the power source observer 14, and the machine controller 8 may comprise memory and/or other storage components configured to retain data maps, look-up tables, algorithms, programs, sensed operating characteristics, and/or other information used to operate the machine and/or the control system 24.

In exemplary embodiments, the control system 24 may use observed and/or otherwise determined operating characteristics, and/or signals received from one or more of the sensors described herein, to determine one or more parameters associated with the transmission 11, the power source 17, the parasitic loads 22, and/or the machine. Such parameters may include but are not limited to, for example, an output torque generated by the power source 17, the output torque generated by the transmission 11, a target torque of the transmission 11, and a virtual retarding torque. Such parameters may further include a torque demand from one or more of the parasitic loads 22, a power source speed error, a torque distribution, and one or more torque priority values associated with the one or more parasitic loads 22 and the power source 17, respectively. The power source output torque, transmission output torque, target torques, torque demand, power source speed error, torque distribution, torque priority values, and/or other parameters described herein may be determined in an open-loop or a closed-loop manner by the control system 24. Such parameters may be used to assist in, for example, braking the machine and/or otherwise controlling the transmission 11, the power source 17, the parasitic loads 22, and/or other machine components. Such parameters may also be used to assist in, for example, limiting a decrease in power source speed during operating conditions in which a cumulative torque demand of the parasitic loads 22 exceeds the peak power source torque described above with respect to FIG. 2.

The power source observer 14 may be configured to monitor one or more operating characteristics of the power source 17 and/or to receive signals indicative of one or more such operating characteristics. For example, the power source observer 14 may receive the power source speed signal 13 described above with respect to power source speed sensor 26. In addition, the power source observer 14 may monitor the operation of the fuel injectors 29 through a power source fuel setting signal 15 and a power source fuel injection timing signal 16. Such signals may be provided to the power source observer 14 via one or more sensors (not shown) associated with the fuel injectors 29. In exemplary embodiments, the power source observer 14 may use one or more such inputs to estimate, calculate, and/or otherwise determine the output torque generated by the power source 17. In exemplary embodiments, the output torque of the power source 17 may also be determined based on, among other things, ambient temperature, ambient humidity, power source load, machine travel speed, and/or other known parameters. The determined power source torque may be sent to the transmission controller 12 via a torque signal 23. Additionally, the power source speed, power source torque, and or other operating characteristics or determined parameters may be sent from the power source observer 14 to the machine controller 8 wirelessly and/or via one or more known connections.

The transmission controller 12 may be configured to monitor operating characteristics and/or receive signals indicative of one or more operating characteristics of the transmission 11 and/or the parasitic loads 22. For example, the transmission controller 12 may be configured to receive inputs including the transmission speed signal 7 from speed sensor 27, a pump and motor displacement signal 5 from ratio controller 33, and the fluid pressure signal 4 from pressure sensor 36. The transmission controller 12 may also receive the power source speed signal 13 discussed above with respect to the power source speed sensor 26, and the torque signal 23 generated by the power source observer 14. In exemplary embodiments in which the transmission 11 comprises an electric CVT, the transmission controller 12 may also be configured to receive inputs including, for example, a torque command signal from ratio controller 33, and the transmission speed signal 7 from transmission speed sensor 27. The transmission controller 12 may determine one or more parameters of the machine, the parasitic loads 22, and/or the transmission 11 based on such inputs, and may generate one or more control commands based on the determined parameters. For example, the transmission controller 12 may determine an output torque of the transmission 11 exerted on countershaft 10, through one or more torque algorithms, using the pump and motor displacement signal 5, the fluid pressure signal 4, the power source speed signal 13, and/or the torque signal 23 as algorithm inputs.

In further exemplary embodiments, the transmission controller 12 may be configured to determine one or more target torques associated with the power source 17. As used herein, the term “target torque” may be defined as a transmission output torque value that is determined to minimize the time required for the power source output torque to reach the torque limit. For example, as illustrated in FIG. 2, a unique target torque value may be calculated, estimated, and/or otherwise determined substantially continuously, sequentially, and/or at any time or power source speed interval. Such target torque values may be used to control operation of the transmission 11 and/or the power source 17 to assist in braking the machine under relatively heavy load conditions, and at any machine travel speed.

For example, the transmission controller 12 may direct the transmission 11 to rotate the countershaft 10 and/or the output shaft 9 at a speed corresponding to the one or more determined target torques. By rotating the counter shaft 10, and/or the output shaft 9 at such speeds, the transmission controller 12 may direct the transmission 11 to generate an output torque at the countershaft 10 and/or the output shaft 9 equal to the one or more target torques. In still further embodiments, the transmission controller 12 may direct the transmission 11 to generate any other known output indicative of, corresponding to, and/or equal to the one or more target torques. Such transmission outputs may be generated at, for example, any interface between the transmission 11 and the power source 17. Such transmission outputs may, for example, increase a speed of the power source 17 and/or decrease a travel speed of the machine.

In exemplary embodiments, one or more target torques may be determined in response to a signal indicative of a desired change in machine travel direction, such as from a forward direction to a reverse direction or from the reverse direction to the forward direction. One or more target torques may also be determined in response to determining that a grade of a surface on which the machine is located exceeds a grade threshold. Such travel direction, surface grade, and/or other determinations used to trigger determination of one or more target torques may be made by the transmission controller 12 using signals received from various sensors, control components, or other known devices associated with the machine.

In exemplary embodiments, one or more target torques may comprise a sum, a function, and/or any other arithmetic combination of the torque limit associated with the power source 17 and the virtual retarding torque. For example, as illustrated in FIG. 2, at a given power source speed, each target torque value may be equal to the sum of the static torque limit value and the virtual retarding torque. As used herein, the term “virtual retarding torque” may be defined as the amount, range, and/or magnitude of torque by which the target torque exceeds the torque limit. The virtual retarding torque may be a dynamic range of torque values, and the magnitude of the virtual retarding torque may be a function of power source speed. Collectively, the determined target torque values may be representative of the virtual retarding torque illustrated in FIG. 2, and the magnitude of the virtual retarding torque may go to zero as the power source torque approaches the torque limit.

In exemplary embodiments, the virtual retarding torque, and thus the individual target torque values collectively making up the virtual retarding torque, may be a function of power source speed. For example, the virtual retarding torque may be based on a difference between the power source speed and a power source speed threshold 21. As used herein, the term “power source speed threshold” may be defined as the maximum speed at which the power source 17 may be operated before damaging a power source component or a component coupled to and/or otherwise driven by the power source 17. In exemplary embodiments, the magnitude of the virtual retarding torque may decrease as a difference between the power source speed and the power source speed threshold 21 decreases. In addition, the magnitude of the virtual retarding torque may decrease as, for example, the power source torque increases in magnitude in the negative direction (i.e., decreases). In particular, the magnitude of the virtual retarding torque may decrease as the retarding torque provided by the power source 17 increases to its maximum value at the torque limit. As noted above, the maximum retarding torque of the power source 17 may have a negative value at the torque limit. Additionally, when the power source 17 reaches the torque limit during, for example, a machine braking operation, the target torque may have a value equal to the torque limit. Further, when the target torque equals the torque limit, the virtual retarding torque may be about zero.

With continued reference to FIG. 1, the machine controller 8 may be configured to monitor operating characteristics and/or receive signals indicative of one or more operating characteristics of the transmission 11, the power source 17, and/or the parasitic loads 22. For example, the machine controller 8 may be configured to receive inputs including the transmission speed signal 7 from speed sensor 27 and/or from the transmission controller 12. The machine controller 8 may also receive a signal generated by the transmission controller 12 indicative of the transmission output torque. In addition, the machine controller 8 may receive one or more signals generated by the power source observer 14. Such signals may be indicative of, for example, the power source output torque and/or the power source speed. In further exemplary embodiments, the machine controller 8 may receive the power source speed signal 13 from the power source speed sensor 26. In addition, the machine controller 8 may receive one or more signals from the respective parasitic loads 22 and/or sensors associated with the parasitic loads 22. Such signals may be indicative of for example, a fluid pressure, a load, and/or a torque demand or request associated with the respective parasitic load 22. For example, the machine controller may be in communication with each of the parasitic loads 22 and may receive a respective torque demand from each parasitic load 22. Such a respective “torque demand” may be defined as the torque requested and/or required by the parasitic load 22 to accomplish a given task or operation.

The machine controller 8 may determine one or more parameters of the machine, the parasitic loads 22, the power source 17, and/or the transmission 11 based on such inputs, and may generate one or more control commands based on the determined parameters. For example, the machine controller 8 may determine a cumulative torque demand based on each of the each of the respective torque demands received from the parasitic loads 22. Such a cumulative torque demand may be a sum of such individual respective torque demands and may further include a minimum power source torque. Such a “minimum power source torque” may be defined as the torque generated by the power source 17 when the power source 17 is operated at a minimum speed required to prevent lugging and/or power source stall. For example, a minimum speed required to prevent lugging of an exemplary power source may be between approximately 400 rpm and approximately 600 rpm, and corresponding exemplary minimum power source torques may be between approximately 1300 Nm and approximately 1450 Nm. In exemplary embodiments, the machine controller 8 may be configured to compare torque demands, such as the cumulative torque demand, to the peak power source torque described above with respect to FIG. 2. In situations where the machine controller 8 determines that a torque demand exceeds the peak power source torque, the machine controller 8 may initiate an underspeed control strategy in which the power source 17 is controlled to operate above the minimum speed required to prevent lugging. Such an underspeed control strategy may be associated with an operating condition in which a reduction in a speed, torque, and/or other output of the power source 17 is limited to prevent power source lugging.

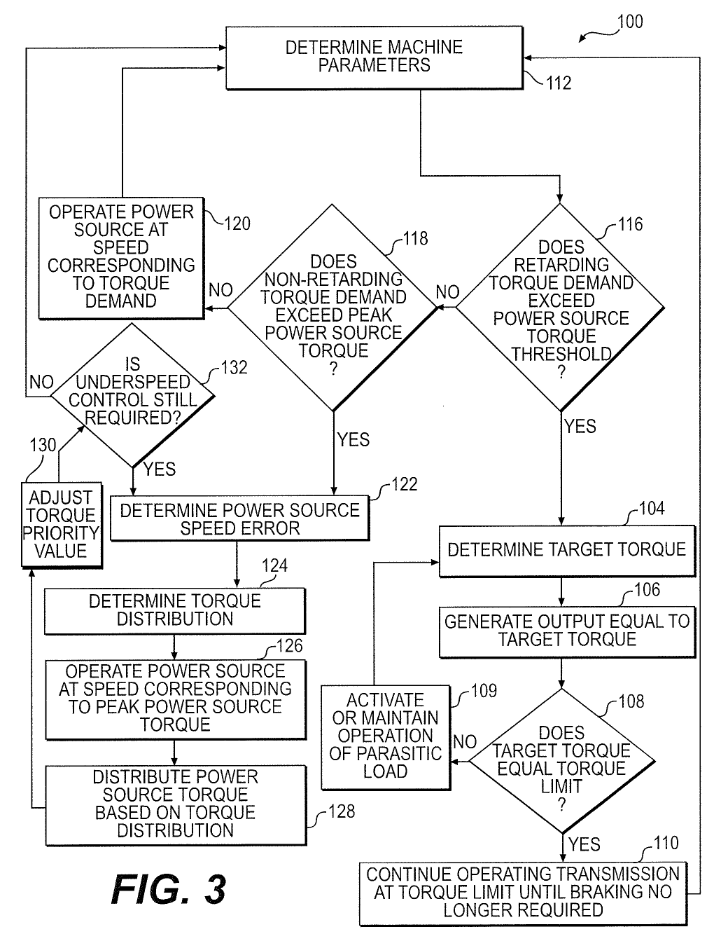

For example, as will be described in detail below with respect to FIG. 3, during such underspeed control, the machine controller 8 may determine a difference between power source speed and an underspeed setpoint that is stored within a memory of the machine controller 8 and/or is otherwise predetermined. As used herein, the term “underspeed setpoint” may be defined as a power source speed that is equal to or associated with a power source speed required to generate the peak power source torque. For example, if peak power source torque is generated at approximately 1200 rpm, the underspeed setpoint may be equal to 1200 rpm or some percentage of 1200 rpm. Such an exemplary percentage may be equal to between approximately 90 percent and approximately 100 percent. For example, if peak power source torque is generated at approximately 1200 rpm and the exemplary percentage described above is equal to approximately 96 percent, the underspeed setpoint may be equal to approximately 1152 rpm. Such an exemplary difference between the power source speed and the underspeed setpoint may be determined in a closed-loop manner during operation of the power source 17, and this difference may be referred to as the “power source speed error” for the duration of this disclosure. It is understood that the power source speed error may comprise a discrepancy between actual power source speed and desired power source speed (i.e., the underspeed setpoint). Such power source speed error may vary during underspeed control of the machine due to, for example, rapid variations in power source speed, and such variations in power source speed may be the result of corresponding changes in torque demand. As will be described below, minimizing power source speed error in response to such variations in power source speed and/or torque demand may maximize the efficiency of the machine in underspeed conditions.

In exemplary embodiments, the machine controller 8 may also be configured to determine a torque distribution associated with the power source 17 and the one or more parasitic loads 22 receiving power from the power source 17. As used herein, the term “torque distribution” may be defined as the allocation of power source torque to and/or between the parasitic loads 22. In exemplary embodiments, such a torque distribution may comprise a portion of power source torque that is allocated and/or otherwise reserved for operation of the power source 17 itself. For example, a torque distribution determined by the machine controller 8 may set aside and/or otherwise reserve a portion of the torque generated by the power source 17 during conditions in which the torque demand exceeds the peak power source torque. By reserving a portion of the generated power sourece torque during such conditions, the exemplary torque distributions determined by the machine controller 8 may prevent power source lugging caused by over-allocating power source torque to the parasitic loads 22. The torque distribution may be determined, in a closed-loop manner, using one or more algorithms stored in the memory of the machine controller 8. Such algorithms may use the power source speed, power source speed error, and/or any other operating characteristics or parameters described herein as inputs.

For example, such algorithms may determine the torque distribution based on the power source speed error and respective torque priority values associated with the power source 17 and the one or more parasitic loads 22. As used herein, the term “torque priority value” may be defined as a weighing factor and/or other algorithm term assisting in governing the percentage of torque allocated to the respective machine component. In exemplary embodiments, each torque priority value may comprise an algorithmic gain on which the torque distribution is based, and the respective torque priority values associated with the power source 17 and the various parasitic loads 22 may be adaptively modified and/or otherwise adjusted during underspeed control of the machine. For example, when the machine is operating at relatively low travel speed and relatively high load, such as when the machine begins to travel in a reverse direction away from a pile with a fully-loaded bucket of material, the torque priority value of the bucket may be relatively greater than the torque priority value of the traction devices. It is understood, however, that as the travel speed of the machine increases in the reverse direction, the torque priority value of the traction devices may increase relative to the torque priority value of the bucket. It is also understood that a toque priority value of the power source 17 may decrease during such operations. However, the torque priority value of the power source 17 may be maintained at or above a minimum priority value to prevent power source lugging. As will be described in greater detail below, such torque priority values may be adjusted, in a closed-loop manner, until underspeed control of the machine is no longer required.

### INDUSTRIAL APPLICABILITY

The disclosed systems and methods have wide applications in a variety of machines including, for example, wheel loaders and track-type tractors. The disclosed systems and methods may be implemented into any machine that utilizes a transmission to convert rotational speed of a power source into a drive speed for a traction device. For example, the disclosed systems and methods may be used by any machine employing a power source, a CVT, and/or one or more parasitic loads. Such parasitic loads may receive power from the power source in order to perform a variety of tasks, and may be operable to assist in machine braking.

During an exemplary machine braking operation, such as an operation necessitating braking the machine at relatively high load, it may be necessary to selectively maximize the torque available for machine braking. However, maximizing such retarding torque does not happen instantaneously in mechanical systems. For example, it may take time (typically on the order of seconds) for the power source 17 to respond to a command requiring the power source 17 to reach the power source speed threshold 21 and/or to reach the torque limit. This time delay associated with maximizing the retarding torque available to the machine may hinder the productivity and load cycle efficiency of the machine, particularly, when the machine is used to perform tasks in which repetitive braking at relatively high loads is required.

Such tasks may include, for example, moving a pile of material from a first location to a second location different than the first location. In performing such a task, an implement of the machine, such as a bucket, may be loaded with the material, and the machine may then be directed to move in the reverse direction, away from the pile, at high load. At some point, the machine must then transition, at high load, from traveling in the reverse direction to traveling in a forward direction toward a desired material deposit location (i.e., the second location). In conjunction with activating one or more parasitic loads 22 thereon, the power source 17 and the transmission 11 may be used to assist in braking the machine during such high-load direction changes. It may be preferable to use these machine components to assist in braking the machine during high-load direction changes rather than, for example, using service brakes associated with the machine traction devices due to the power losses and other inefficiencies associated with the application of such service brakes.

To facilitate using the power source 17, transmission 11, and parasitic loads 22 to assist in braking the machine in high load situations, the exemplary control strategies of the present disclosure may increase power source speed to the power source speed threshold 21, based on closed-loop determinations of a virtual retarding torque. In such embodiments, the virtual retarding torque may comprise sequentially-determined target torque values that serve as transmission output torque commands. By actively controlling the output torque generated by the transmission 11 in a closed-loop manner using such target torque values, the power source retarding torque may be maximized as quickly as possible.

For example, the output torque generated by the transmission 11 based on such target torque values may minimize the time required for the power source 17 to reach the torque limit. In exemplary embodiments, the target torque values may be determined according to one or more control algorithms formulated to bring the power source 17 to the torque limit as quickly as possible without causing failure to the components and/or couplings associated with the power source 17, transmission 11, and parasitic loads 22. Such target torque values may also increase the speed of the power source 17 until the power source speed threshold 21 is reached. It is understood that in exemplary embodiments in which the power source speed increases beyond, for example, the power source speed threshold 21, exemplary control algorithms of the present disclosure may determine one or more target torque values having a positive sign and/or any other magnitude (positive or negative) to assist in reducing the power source speed to the power source speed threshold 21. Additionally, the target torque values may be determined so as to limit the rate at which the power source 17 approaches the target torque, thereby minimizing operator discomfort and/or material spillage caused by braking the machine too abruptly. For example, during an exemplary machine braking situation, the transmission control system 24 may activate one or more parasitic loads 22 sequentially to avoid abrupt machine braking and/or material spillage.

In addition, the disclosed systems and methods may be used to prevent damage to the power source 17 in underspeed conditions. For example, in order to move a pile of material from a first location to a second location different than the first location, the machine may be driven into the pile in order to assist in loading the bucket with material. Upon impact, the travel speed of the machine may approach zero, and the machine operator may raise and/or tilt the bucket to complete the bucket loading process. In order to compensate for the resulting increase in torque demand from the bucket, the power source speed may instantly increase, thereby causing a corresponding increase in power source torque. If, however, the torque demand received from the bucket and/or the traction devices of the machine exceeds the peak power source torque, the power source may not be capable of satisfying this demand. Thus, once the peak power source torque is reached, the power source speed may rapidly decrease. In order to prevent power source lugging in such extreme load conditions, exemplary embodiments of the present disclosure may reserve a portion of the power source torque to maintain stable operation of the power source. As a result, the amount of torque distributed to the bucket may be limited during periods of peak demand in order to prevent the power source lugging described above. Additionally, in such extreme load conditions the power source torque may be distributed based on power source speed error as well as respective torque priority values associated with the power source, the bucket, and/or the traction devices of the machine. Such torque priority values, and the corresponding torque distribution, may be determined in a closed-loop manner, and the torque priority values may be modified in response to changes in the power source speed error. Such modifications to the torque priority values may assist in reducing the power source speed error during operation in underspeed conditions.

By distributing power source torque between the power source, the bucket, and/or the traction devices based on adaptively controlled torque priority values, embodiments of the present disclosure may improve the operational efficiency of the machine during underspeed conditions. For example, such underspeed control may responsively and variably maximize the distribution of torque to the various parasitic loads in extreme load conditions while, at the same time, maintaining a sufficient minimum power source speed to prevent lugging. As a result, the systems and methods of the present disclosure may have a number of advantages over known systems and methods of power source control. For example, known systems and methods of power source control are not be capable of modifying torque priority values in response to changing power source speeds in underspeed conditions. Thus, in such conditions, known systems typically reserve more torque for the power source than necessary in order to provide a sufficient buffer against lugging. As a result, operation of the corresponding parasitic loads may not be optimized in such conditions. An exemplary method of controlling a transmission 11, a power source 17, and one or more parasitic loads 22 associated with a machine will now be explained with reference to the flow chart 100 illustrated in FIG. 3.

In an exemplary control method, the various sensors described herein may substantially continuously sense, detect, calculate, observe, and/or otherwise determine respective operating conditions of the machine. As noted above, such operating conditions may include, among other things, power source speed, transmission speed, fluid pressure, implement loads, and a torque demand corresponding to each parasitic load 22. The sensors may substantially continuously send signals indicative of such operating characteristics to one or more of the machine controller 8, the transmission controller 12, and the power source observer 14, and these components of the control system 24 may determine one or more machine parameters (Step: 112) using the information contained in such signals as inputs. For example, upon receiving a torque demand from one or more of the parasitic loads 22, the machine controller 8 may determine a cumulative torque demand indicative of the total torque required to accomplish the present operation or task. The machine controller 8 may also determine whether the torque demand corresponds to a required retarding torque (i.e., whether the torque being requested by the parasitic loads 22 is intended for use in braking the machine) or a required non-retarding torque. The machine controller 8 may make such a determination based on, for example, signals received from a throttle pedal position sensor and/or signals received from one or more of the operator interfaces described herein, such as the forward-neutral-reverse selector. For example, the machine controller 8 may determine that a torque demand corresponds to a required retarding torque based on signals indicative of a machine operator's desire to change machine travel direction and/or to reduce machine travel speed.

At Step: 116, the machine controller 8 and/or the transmission controller 12 may determine whether the torque demand exceeds the power source torque threshold 18. In particular, if the cumulative torque demand comprises a required and/or requested retarding torque, the magnitude of which exceeds the power source torque threshold 18 (Step: 116—Yes), machine braking may be initiated by the control system 24. Machine control may then proceed to Step 104. Alternatively, if the required retarding torque does not exceed the power source torque threshold (Step: 116—No), the torque demand may comprise a non-retarding torque, and machine control may proceed to Step: 118. As will be discussed in greater detail below, at Step: 118 the machine controller 8 may compare the required torque to the peak power source torque, and may determine whether or not to initiate underspeed control of the machine based on this comparison.

First, with respect to the exemplary methods of machine braking described herein, it is understood that such braking control may be initiated based on the determination made at Step: 116 in conjunction with one or more additional determinations and/or inputs. For example, one or more sensors associated with the machine may measure, detect, and/or otherwise determine a grade of a surface on which the machine is located. The machine controller 8 and/or the transmission controller 12 may be configured to initiate machine braking in response to a determination that the grade of the surface on which the machine is located exceeds a predetermined grade threshold, in addition to and/or in combination with the determination made at Step: 116. In such exemplary embodiments, the grade threshold may be indicative of either an inclined grade or a declined grade.

In further exemplary embodiments, the transmission controller 12 and/or the machine controller 8 may receive one or more signals indicative of a desired change in machine travel direction. For example, upon removing material from a pile and backing away from the pile, an operator of the machine may manipulate and/or otherwise transition the forward-neutral-reverse selector and/or other like operator interface associated with the machine to change the travel direction of the machine from reverse to forward. The machine controller 8 and/or the transmission controller 12 may be configured to initiate machine braking in response to such a signal indicative of a change in desired travel direction, in addition to and/or in combination with the determination made at Step: 116.

At Step: 104, the transmission controller 12 may determine a target torque of the transmission 11, such as a first target torque of the transmission 11. Such an exemplary first target torque may comprise a combination of the torque limit associated with the power source 17 and the virtual retarding torque described above. The transmission controller 12 may utilize one or more algorithms, maps, and/or look-up tables in determining the target torque at Step: 104. For example, the transmission controller 12 may use one or more of the fluid pressure signal 4, pump and motor displacement signal 5, transmission speed signal 7, power source speed signal 13, and/or torque signal 23 as inputs to one or more target torque algorithms, and the first target torque may be an output of such algorithms.

At Step: 106, the transmission controller 12 may direct the transmission 11 to generate an output at the countershaft 10 corresponding and/or equal to the first target torque generated at Step: 104. For example, the transmission 11 may rotate the countershaft 10 at a speed enabling the countershaft 10 to deliver an output torque to the power source 17 that is equal to the first target torque. The rotation of the countershaft 10 and/or other output of the transmission 11 may have the effect of increasing a speed of the power source 17 from a first power source speed to a second power source speed greater than the first. In addition, the rotation of the countershaft 10 and/or other output of the transmission 11 may have the effect of decreasing the travel speed of the machine from a first travel speed to a second travel speed less than the first travel speed. Thus, the transmission may use the first target torque to assist in braking the machine.

At Step: 108, the transmission controller 12 may determine whether the target torque determined at Step: 104 is equal to the torque limit associated with the power source 17. For example, if the transmission controller 12 determines that the first target torque does equal the torque limit (Step: 108—Yes), the transmission controller 12 may continue to operate the transmission 11 at the torque limit until braking of the machine is no longer required (Step: 110). The transmission controller 12 may determine that braking is no longer required in a variety of ways, such as, for example, upon receiving a signal from a throttle pedal position sensor and/or from one or more operator interfaces indicative of a desire to accelerate the machine, or to change a travel direction of the machine from forward to reverse.

Alternatively, if the transmission controller 12 determines that the first target torque does not equal the torque limit (Step: 108—No), the transmission controller 12 may return to Step: 104, and may sequentially determine at least one additional target torque until a first of the additional target torques is equal to the torque limit. For example, in response to determining that the first target torque is not equal to the target torque, the transmission controller 12 may return to Step: 104 and may determine a second target torque of the transmission 11. In exemplary embodiments, the magnitude of the virtual retarding torque may decrease as the speed of the power source 17 increases toward the power source speed threshold 21, thus, the second target torque may be less than (i.e., may have a greater magnitude in the negative direction than) the first target torque. Sequentially determining additional target torques until a first of the additional target torques equals the torque limit may assist in braking the machine by maximizing the retarding torque available for braking in as little time as possible. Additionally, the one or more algorithms employed at Step: 104 may be configured to limit the rate at which retarding torque is applied to, for example, the traction devices of the machine and/or other components. Thus, while assisting in minimizing the time required to brake the machine during, for example, high-load direction changes, such algorithms may be tuned to avoid machine jerking, material spillage, and/or other drawbacks associated with relatively abrupt braking.

In further exemplary embodiments, the transmission control system 24 may activate or maintain operation of a parasitic load 22 associated with the power source 17 and/or the transmission 11 (Step: 109) in response to determining that the first target torque is not equal to the torque limit (Step: 108—No). In exemplary embodiments, such parasitic loads 22 may be activated sequentially. For example, a first parasitic load 22 may be activated at Step: 109 in response to a first determination made at Step: 108, and a second parasitic load 22 may be activated at Step: 109 in response to a subsequent second determination made at Step: 108. Alternatively, such parasitic loads 22 may be activated based on the speed of the power source 17. For example, once machine braking has been initiated, a first parasitic load 22 may be activated in response to the power source 17 reaching a first power source speed, and a second parasitic load 22 may be activated in response to the power source 17 reaching a second power source speed greater than the first power source speed. The sequential activation of such parasitic loads 22 may assist in braking the machine by increasing the load demand on the power source 17 and/or the transmission 11. Additionally, such sequential activation may result in a more gradual braking of the machine than simultaneous activation of more than one parasitic load 22. Thus, such sequential parasitic load activation may assist in avoiding operator discomfort and/or other inefficiencies associated with braking the machine abruptly.

As described above, control of the transmission 11, power source 17, and/or parasitic loads 22 described herein may continue in a closed-loop manner, in accordance with the methods illustrated in flow chart 100, until machine braking is no longer required. With reference to Step: 104, it is understood that once a second target torque has been generated, the transmission controller 12 may direct the transmission 11 to generate a second output equal to the second target torque at the interface between the transmission 11 and the power source 17 (Step: 106). As described above with respect to the first target torque, such an output may comprise rotation of the countershaft 10 at a speed enabling the countershaft 10 to deliver an output torque to the power source 17 equal to the second target torque. This rotation of the countershaft 10 and/or other output of the transmission 11 may have the effect of increasing a speed of the power source 17 from the second power source speed to a third power source speed greater than the second. In addition, the rotation of the countershaft 10 and/or other output of the transmission 11 may have the effect of decreasing the travel speed of the machine from the second travel speed to a third travel speed less than the second travel speed.

In such closed-loop control methods, once the transmission controller 12 determines that a second, third, and/or subsequent additional target torque generated at Step: 104 is equal to the torque limit (Step: 108—Yes) the speed of the power source 17 may be increased to the power source speed threshold 21. This speed increase may be driven by the transmission 11 through an increase in the rotation speed and/or output torque of the countershaft 10. This speed increase may also be affected by directing one or more speed increase commands from the control system 24 to the power source 17. In addition, once the transmission controller 12 determines that the second, third, and/or subsequent additional target torque generated at Step: 104 is equal to the torque limit (Step: 108—Yes) the torque required and/or demanded by one or more of the parasitic loads 22 described herein may be increased to the corresponding parasitic load torque threshold 19. Such an increase in the torque required by the parasitic load 22 may further assist in machine braking.

In such exemplary embodiments, it is understood that a target torque having a value equal to the torque limit, and/or a power source speed having a value equal to the power source speed threshold 21 may indicate that the combined machine braking and/or retarding capabilities of the power source 17, transmission 11, and parasitic loads 22 have been maximized. Further, the active closed-loop determination of one or more target torques may assist in minimizing the time required to brake the machine. Minimizing the time associated with braking the machine in this way may improve, for example, machine efficiency during high-load direction changes and/or other like braking operations.

With reference to Step: 118, if the machine controller 8 determines that the torque demand comprises a required non-retarding torque, and that this torque demand does not exceed the peak power source torque (Step: 118—No), the control system 24 may operate the power source 17 at a speed corresponding to the torque demand (Step: 120). In such operating conditions, the power source 17 may be fully capable of providing sufficient output torque to satisfy the demands of the various parasitic loads 22.

If, on the other hand, the machine controller 8 determines that the torque demand exceeds the peak power source torque (Step: 118—Yes), underspeed control of the machine may be initiated in order to prevent power source lugging, and control may proceed to Step: 122 in response to the determination made at Step: 118. In exemplary embodiments, such a torque demand may be received from the one or more parasitic loads 22 upon impacting a pile of material with the machine. At impact, the travel speed of the machine may be approximately zero, and the torque demand may result in an increase in power source torque to the peak power source torque. As described above, in exemplary embodiments, power source speed may responsively decrease in response to the power source torque reaching the peak power source torque.

At Step: 122, the machine controller 8 may determine the power source speed error. As described above, the power source speed error may comprise a difference between power source speed and the underspeed setpoint associated with the peak power source torque. During the closed-loop underspeed control method illustrated in FIG. 3, the power source speed error may change (i.e., decrease) as a result of controlled changes in power source speed. At Step: 124, the machine controller 8 may determine a torque distribution associated with the power source 17 and the one or more parasitic loads 22, and the torque distribution may be based on the power source speed error generated at Step: 122. The torque distribution may also be based on respective torque priority values associated with the power source 17 and the parasitic loads 22 from which the torque demand is received. It is understood that each torque priority value may comprise a gain and/or other algorithmic element used to determine the torque distribution, and one or more of the torque priority values may be adjusted at Step: 130 during the exemplary closed-loop underspeed control method of FIG. 3. During such control methods, such adjustment may reduce, decrease, and/or substantially eliminate the power source speed error. Such adjustment may also limit the decrease in power source speed during such underspeed control, thereby prohibiting power source lugging.

For example, during operating conditions in which the peak power source torque is insufficient to satisfy the cumulative parasitic load torque demand, the power source 17 may be operated at a speed corresponding to and/or otherwise enabling generation of the peak power source torque (Step: 126). The control system 24 may distribute the resulting power source torque to the parasitic loads 22 based on the torque distribution determined at Step: 124 (Step: 128). The torque distribution determined at Step 124 may maximize the power source torque provided to the parasitic loads 22 while maintaining and/or reserving a percentage and/or portion of the generated torque as necessary to prevent power source lugging. In particular, by reserving a portion of the power source torque in this way, the power source speed may be maintained above a power source speed threshold below which lugging may be known to occur. In addition, as a result of such control, the torque provided to one or more of the parasitic loads 22 based on the torque distribution may be less than the respective torque demand associated with the parasitic load 22.

Upon distributing the power source torque based on the torque distribution (Step: 128) the machine controller 8 may adjust one or more of the torque priority values as described above (Step: 130). The one or more torque priority values may be modified, in a closed-loop manner, until the machine controller 8 determines that underspeed control is no longer required (Step: 132—No). For example, one or more torque priority values may be modified until the machine controller 8 determines that the power source torque required to satisfy the torque demand no longer exceeds the peak power source torque. Adjustment of the one or more torque priority values may be accomplished using any of the operating characteristics or determined machine parameters discussed herein. For example, the machine controller 8 may use one or more of power source speed, power source torque, the respective torque demands of the parasitic loads 22, and/or other characteristics or parameters as inputs into one or more torque priority value algorithms. Such algorithms may generate respective modified torque priority values as outputs, and such modified torque priority values may be determined, in a closed-loop manner, to reduce and/or substantially eliminate the power source speed error. In particular, sequentially distributing power source torque based on such modified torque priority values based on the closed-loop underspeed control method of FIG. 3 may assist in operating the power source 17 at speeds matching the underspeed setpoint as closely as possible during periods of extreme parasitic load demand. As a result of such adaptive and/or otherwise responsive torque priority value control, torque distribution to the respective parasitic loads 22 may be optimized while preventing power source lugging.

For example, if the machine controller 8 determines that underspeed control is still required after distributing power source torque in accordance with the determined torque distribution (Step: 132:—Yes), control may return to Step: 122 for determination of a second, subsequent, and/or at least one additional power source speed error. The machine controller 8 may determine a second, subsequent, and/or at least one additional torque distribution at Step 124 based on the modified torque priority value determined at Step: 130. The at least one additional torque distribution may also be based on an updated power source speed. It is understood that this updated power source speed may be a current power source speed that has changed as a result of the control functions performed at Steps: 128 and 130. As described above, the at least one additional torque distribution determined at Step: 124, in a closed-loop manner, may assist in limiting a decrease in power source speed in operating conditions in which the torque demand exceed the peak power source torque. Additional torque distributions may be determined corresponding to each modified torque priority value until the torque demand no longer exceeds the peak power source torque.

As illustrated by the flow chart 100 of FIG. 3, exemplary methods of the present disclosure may be useful in controlling a power source 17, transmission 11, and/or parasitic loads 22 of a machine in response to a retarding torque demand exceeding the power source torque threshold 18 and in response to a non-retarding torque demand exceeding the peak power source torque. Thus, the exemplary control methods described herein may be employed at any power source speed and/or power source torque. At elevated power source torques proximate the peak power source torque, the underspeed control methods described herein may adaptively vary and/or otherwise control the distribution of torque to the parasitic loads 22 in order to maximize the performance of such loads while, at the same time, minimizing a reduction in power source speed and preventing power source lugging. On the other hand, in order to facilitate machine braking the exemplary control methods described herein may adaptively increase the speed of the power source 17 to the power source speed threshold 21 using the transmission 11. Such methods may also sequentially activate one or more of the parasitic loads 22 to increase the available retarding torque, thereby further assisting in machine braking.

Other embodiments of the invention will be apparent to those skilled in the art from consideration of the specification, and practice of the systems and methods disclosed herein. It is intended that the specification and examples be considered as exemplary only, with a true scope of the invention being indicated by the following claims.

What is claimed is:

1. A method of controlling a power source associated with a machine, comprising:
determining a difference between an underspeed setpoint associated with a peak power source torque, and a first power source speed;
determining a torque distribution associated with the power source and at least one parasitic load receiving power from the power source, wherein the torque distribution is based on the difference and respective torque priority values associated with the power source and the at least one parasitic load;
providing torque from the power source to the at least one parasitic load based on the torque distribution; and
modifying at least one of the respective torque priority values, wherein modifying at least one of the torque priority values reduces a difference between the underspeed set point and a second power source speed different than the first power source speed.

2. The method of claim 1, further including receiving a torque demand from the at least one parasitic load; and
determining that the torque demand exceeds the peak power source torque.

3. The method of claim 2, further including determining the difference between the underspeed setpoint and the first power source speed in response to determining that the torque demand exceeds the peak power source torque.

4. The method of claim 2, further including modifying the at least one of the respective torque priority values, in a closed loop manner, until determining that the torque demand no longer exceeds the peak power source torque.

5. The method of claim 2, wherein the torque demand is received from the at least one parasitic load when a travel speed of the machine is approximately zero, the torque demand resulting in an increase in power source torque to the peak power source torque, wherein power source speed decreases in response to the power source torque reaching the peak power source torque.

6. The method of claim 5, wherein modifying at least one of the respective torque priority values limits the decrease in power source speed.

7. The method of claim 1, wherein the underspeed setpoint comprises a percentage of a power source speed required to generate the peak power source torque.

8. The method of claim 1, wherein the torque provided to the at least one parasitic load based on the torque distribution is less than a torque demand received from the at least one parasitic load.

9. The method of claim 1, wherein providing torque from the power source to the at least one parasitic load comprises operating the power source at a speed required to generate the peak power source torque.

10. The method of claim 1, further including operating the power source at the second power source speed, wherein modifying at least one of the respective torque priority values alters a torque amount reserved for the power source when operating at the second power source speed.

11. A method of controlling a power source associated with a machine, comprising:
determining a cumulative torque demand based on signals received from an implement and a traction device, the implement and the traction device receiving power from the power source;
determining that the torque demand exceeds a peak power source torque;
determining, in response to determining that the torque demand exceeds the peak power source torque, a first difference between a first power source speed and an underspeed setpoint;
determining a first torque distribution associated with the power source, the implement, and the traction device, wherein the first torque distribution is based on the first difference and respective torque priority values associated with the power source, the implement, and the traction device;
modifying at least one of the torque priority values to generate a first modified torque priority value based on the first difference; and
determining, in a closed-loop manner, at least one additional torque distribution,
wherein the at least one additional torque distribution is based on the first modified torque priority value and a second power source speed different than the first power source speed, and
wherein the at least one additional torque distribution limits a decrease in power source speed.

12. The method of claim 11, further including modifying the first modified torque priority value, in a closed loop manner, to generate at least one additional modified torque priority value, the at least one additional modified torque priority value being based on a second difference between the second power source speed and the underspeed setpoint.

13. The method of claim 12, wherein modifying the at least one torque priority value results in the second difference being less than the first difference.

14. The method of claim 11, further including providing torque to the implement and the traction device based on the first torque distribution and the at least one additional torque distribution.

15. The method of claim 11, wherein the peak power source torque is between approximately 1200 Nm and approximately 1600 Nm, and wherein the at least one additional torque distribution maintains the power source speed above approximately 400 rpm.

16. The method of claim 11, further including receiving a retarding torque request associated with the traction device; and
determining that the retarding torque request exceeds a power source torque threshold.

17. The method of claim 16, further including determining, in response to determining that the retarding torque request exceeds the power source torque threshold, a plurality of target torques, in a closed-loop manner, until a first target torque of the plurality of target torques equals a torque limit associated with the machine.

18. A machine, comprising:
a power source;
at least one parasitic load receiving power from the power source;
a transmission coupled to the power source; and
a control system in communication with the power source, the at least one parasitic load, and the transmission, wherein the control system is operable to determine a difference between an underspeed setpoint associated with a peak power source torque, and a first power source speed;
determine a torque distribution associated with the power source and the at least one parasitic load, wherein the torque distribution is based on the difference and respective torque priority values associated with the power source and the at least one parasitic load; and
modify at least one of the respective torque priority values, wherein modifying at least one of the torque priority values reduces a difference between the underspeed set point and a second power source speed different than the first power source speed.

19. The machine of claim 18, wherein the at least one parasitic load comprises one of a power source fan and an implement pump.

20. The machine of claim 18, wherein the power source comprises a diesel engine, and the transmission comprises one of an electric continuously variable transmission and a hydraulic continuously variable transmission, the system further including at least one sensor configured to determine the first and second power source speeds, and to direct signals indicative of the first and second power source speeds, respectively, to the control system.
